(19) United States
(12) Patent Application Publication
(10) Pub. No.: US 2015/0321273 A1
(43) Pub. Date: Nov. 12, 2015

(54) BAND GUIDING DEVICE FOR A SAW BAND OF A MACHINE SAW

(71) Applicant: KEURO Besitz GmbH & Co. EDV-Dienstleistungs KG, Achern (DE)

(72) Inventors: Lothar Kuhn, Kappelrodeck (DE); Eric Rohl, Rheinau-Freistett (DE); Sonke Florian Krebber, Baden-Baden (DE); Nicole-Desiree Krebber, Baden-Baden (DE)

(73) Assignee: KEURO BESITZ GMBH & CO. EDV-DIENSTLEISTUNGS KG, Achern (DE)

(21) Appl. No.: 14/706,328

(22) Filed: May 7, 2015

(30) Foreign Application Priority Data
May 7, 2014 (DE) 102014208533.0

(51) Int. Cl. B23D 55/08

(52) U.S. Cl. CPC B23D 55/082

(57) ABSTRACT

A band guiding device for a saw band of a machine saw, having sliding blocks 3 for a sliding contact with the saw band and having a support 2 which can be mounted on the machine saw and on which the sliding blocks 3 are held. The sliding blocks 3 are held on the support 2 by releasable fastening elements 9, 12. The support 2 includes a substantially flat mounting surface 13 for mounting the sliding blocks 3. This mounting surface 13 is provided with a plurality of fastening points 9 for the sliding blocks 3, wherein the number of fastening points 9 is greater than the number of sliding blocks 3.

### INCORPORATION BY REFERENCE

The following documents are incorporated herein by reference as if fully set forth: German Patent Application No. DE 10 2014 208 533.0, filed May 7, 2014.

### BACKGROUND

The present invention relates to a band guiding device for a saw band of a machine saw. This band guiding device includes sliding blocks which are provided for a sliding contact with the saw band. It further includes a support on which the sliding blocks are held by means of releasable fastening means and which can be mounted on the machine saw.

Machine saws with a saw band usually consist of a saw bench on which the material to be sawn is clamped, and a saw upper part which is movable relative to the saw bench and in which the saw band extends around at least two running wheels in order to generate the longitudinal machining movement of the saw teeth that are mounted on the saw band. The saw feed is effected by means of a relative movement between the saw upper part and the saw bench.

In order to stabilize the saw band when sawing and in particular to suppress or minimize oscillations of the saw band or warping, it is usual to provide, as close as possible to the workpiece to be sawn, band guiding device of the type mentioned in the introduction which, as a rule, contact both side faces of the saw band at least at times in a sliding manner and as a result guide them. As a rule, such band guiding device are arranged as close as possible before the entry into the workpiece to be sawn and as close as possible after the exit from the workpiece to be sawn.

Guiding means for the saw band of a band saw are frequently realized in a forceps-like manner, hard metal sliding blocks on both sides of the saw band providing sideways band guiding, whilst the back of the saw band is guided either by running rollers or also by means of hard metal sliding blocks. An example of a corresponding band guiding device is disclosed in DE-A-198 28 589.

In particular in the case of machine saws with high cutting capacities, the side band guiding device are also under high load as the saw band strives to evade the cutting pressure by tipping sideways. This means that the sliding blocks of that side band guiding device which prevent the saw band from tipping are in permanent contact with the saw band and are subject to a high normal force.

Mounting the sliding blocks of band guiding device for a saw band of a machine saw on a corresponding support by means of releasable fastening means has consequently been proposed such that they are able to be replaced with little effort when worn. Examples of this can be found in US-A-2006/0174497 and WO-A-2006/002536.

The higher the cutting capacity of the machine saws, the higher the demands on the band guiding device, in particular on the side band guiding device. Consequently, they have to be adapted in as optimum a manner as possible to the geometry of the saw band as well as to its movement sequence; this latter in particular when the saw band extends around the running rollers in a plane which is inclined with respect to the cutting plane or which is parallel to the cutting plane, for then the saw band, before it enters into the workpiece to be sawn and after it exits from the same, has to be turned into the cutting plane and turned back out of the cutting plane. In addition, care must also be taken to ensure that no chips collect and settle on the band guiding device. Finally, the sliding blocks of the band guiding device have to be arranged such that cooling and lubricating fluid is able to be applied to all the sliding blocks in order to reduce the friction between the sliding blocks and the saw band.

The above demands have resulted in different arrangements of sliding blocks in the prior art. U.S. Pat. No. 3,104,575, for example, discloses band guiding device with sliding blocks which contact the side face of the saw band as much as possible at the same time and over the entire surface, whilst in EP-A-2 158 992 the sliding blocks are set at an angle in order to divert any chips in the direction of its teeth as a result of the movement of the saw band.

### SUMMARY

Proceeding from said prior art, the object underlying the present invention is to provide a band guiding device which corresponds to the different demands outlined above better than before.

This object is achieved by a band guiding device with one or more features of the invention. Preferred developments and further developments of the band guiding device according to the invention are described below and in the claims.

The present invention accordingly provides a band guiding device which includes a support which can be mounted on the machine saw and on which the sliding blocks are held by means of releasable fastening means. The support comprises a substantially flat mounting surface for mounting the sliding blocks. This mounting surface is provided with a plurality of fastening points for the sliding blocks, wherein the number of fastening points is greater than the number of sliding blocks.

As a result, a large amount of flexibility is produced in the arrangement of the sliding blocks of the band guiding device according to the invention, for the sliding blocks can preferably be mounted at many different positions and due to the releasable fastening can also be moved where required. Thus, for example, where the machine saw is converted to a larger width saw band, it is possible to displace the sliding blocks of the band guiding device according to the invention such that the saw band is guided additionally over as much of the entire surface as possible. The sliding blocks can also be moved in order to be able to correspond better to the different demands that arise from different sawn materials and their specific chips. Finally, the sliding blocks can also be moved by way of a wear pattern in order to be able to adapt better on site to specific product requirements.

In the case of the band guiding device according to the invention, it is possible for the first time to arrange the sliding blocks in a variable manner for each intended purpose and, where applicable, even to modify the arrangement on site. In addition, significant savings in the production and in the storage of spare parts are produced as a result of the development of the band guiding device according to the invention as the invention realizes a type of modular system.

The fastening points for the sliding blocks are preferably arranged on the mounting surface of the support in a grid, in particular a regular grid. Such a grid enables a particularly simple adaptation to individual conditions as the sliding blocks can be moved into a particularly large number of positions.

The sliding blocks of the band guiding device according to the invention can be fastened and changed in a very uncomplicated but efficient manner by means of, on the one hand, screws or threaded pins, and, on the other hand, threaded bores, the fastening points in the mounting surface consisting substantially of in each case at least one threaded bore. The sliding blocks can then quite simply be screwed onto the mounting surface of the support.

In this connection, the sliding blocks preferably comprise at least two countersunk bores for inserting screws in a countersunk manner, whilst the fastening points in the mounting surface consist substantially in each case of at least two threaded bores. If the fastening points are arranged in a regular grid, at least two adjacent threaded bores in each case form the corresponding fastening points in the grid.

The advantage of the countersunk bores is that the screws for screw-connecting the sliding blocks can be countersunk inside the same such that the top surfaces of the sliding block, which are provided for sliding contact with the saw band, remain uninfluenced by the screw connection and the screw heads are at all times at a sufficient distance from the saw band, even as the wear on the sliding blocks increases. The providing of two countersunk bores ensures that the sliding blocks can be fastened on the mounting surface with two screws, which fixes it in non-rotatable and sturdy manner.

An alternative realization of the releasable fastening of the sliding blocks on the mounting surface of the band guiding device according to the invention consists in positive locking push-in connections between the sliding blocks and the support. These can be developed in different ways, for example by means of pins, teeth or tongue and groove connections as well as clip connections. In a preferred manner, self-locking pins with clamping sleeves are used, for example in cylindrical form or, on account of the anti-rotation protection, with an angled cross section, the clamping sleeve preventing unintentional release of the positive locking connection and nevertheless making it possible to remove the sliding block from the pin. The removing of the sliding block from the pin is effected, in this case, in a direction in which a force is in no way exerted by the saw band onto the sliding block, namely away from the holding plate.

A further possibility for a positive locking push-in connection consists in that the fastening means can include a groove that is introduced into the mounting surface for receiving a sliding block, wherein the groove comprises a stop face in the direction of movement of the saw band for locating the sliding block. The forces transmitted from the saw band onto the sliding block are then supported, on the one hand, on the groove bottom and, on the other hand, on the stop face. An additional pin with a self-locking clamping sleeve or a screw connection with a screw or a threaded pin, the resistance of which is then of minor importance, can secure the sliding block in the groove, for example, against falling out.

Such a securement can preferably also consist in that the stop face of the groove is provided with an undercut, whilst the sliding block comprises a molded part for inserting into the undercut of the stop face such that a positive locking connection is also created on the stop face against the sliding block falling out of the groove. Nonetheless, the sliding block is able to be removed from the groove again by being pulled out of the undercut on the stop face in the direction opposite the movement of the saw band. Where applicable, it is possible to provide a spring element or a latching element which secures the sliding block in the undercut of the stop face.

Within the framework of the present invention, it is finally preferred when the sliding blocks are produced from a metal powder which is pressed in a mold and hardened as a result of sintering, preferably with rounded or at least chamfered edges, insofar as they come into contact with the saw band. However, the sliding blocks can also be produced from a ceramic material or can be formed from hard metal in a conventional manner.

The releasable mounting according to the invention of the sliding blocks on a flat mounting surface results in a high degree of dimensional stability of the surfaces of the sliding blocks which are to come into contact with the saw band. Post-treating said surfaces of the sliding blocks in order to make the surfaces flat is then not necessary. This has been required for a long time in the prior art as the sliding blocks have been mounted on the supports a result of soldering. However, in the case of soldering it cannot be ensured that the sliding blocks are fastened entirely flatly on the support.

A further advantage of the releasable fastening of the sliding blocks on a flat mounting surface with a plurality of fastening points is additionally the possibility of realizing the sliding blocks in a relatively small manner and leaving large spaces between the individual sliding blocks. At the same time, it is possible as a result of the high dimensional stability of the releasable connection to provide the sliding blocks with a comparatively large height such that, as a result, larger spaces with greater volumes can be provided between the sliding blocks of the band guiding device according to the invention than has been usual up to now in the prior art. Thus, a relatively large distance remains between the mounting surface of the support and the saw band; the clearance created in this connection is comparatively large such that chips passing into the band guiding device for instance cannot cause any problems.

Last but not least, the unusually large height of the sliding blocks also make a long service life of the saws possible as a lot of material for wearing can be provided.

### BRIEF DESCRIPTION OF THE DRAWINGS

Some exemplary embodiments of a band guiding device developed according to the invention are described in more detail and explained below by way of the accompanying drawings, in which:

FIG. 1 shows a schematic perspective representation of a band guiding unit of a machine saw with an exemplary embodiment of a band guiding device according to the invention;

FIG. 2 shows a schematic sectional representation of the band guiding unit from FIG. 1;

FIG. 3 shows a perspective view of a sliding block;

FIG. 4 shows a side sectional representation of a sliding block;

FIG. 5 shows a view of a mounting surface of a support of an exemplary embodiment of a band guiding device according to the invention;

FIGS. 6a-6e show the support from FIG. 5 with variously mounted sliding blocks;

FIG. 7 shows a top view of part of another embodiment of a band guiding device with a sliding block;

FIG. 8 shows a sectional representation of the part of the band guiding device shown in FIG. 7 along the line A-A.

### DETAILED DESCRIPTION OF THE PREFERRED EMBODIMENTS

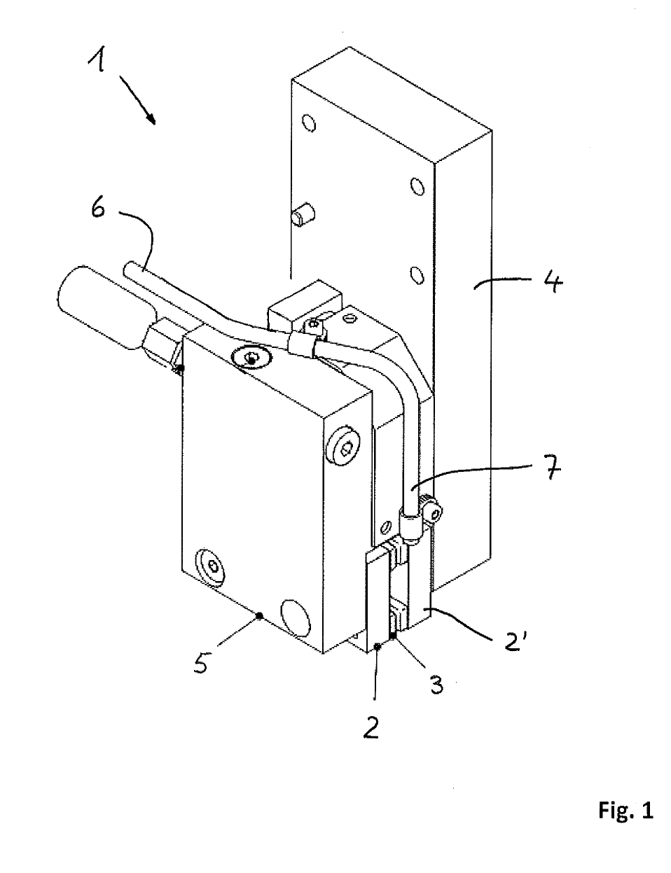

FIG. 1 shows a perspective view of a band guiding unit 1 for a machine saw, as is arranged as a rule before entry and after exit of the saw band (not shown) into or out of the material to be sawn (not shown either). The band guiding unit 1 includes, among other things, two band guiding device which are developed according to the invention and are provided in each case here as a support 2, 2′ with sliding blocks 3 mounted thereon for contact with the side faces of the saw band. Accordingly, the saw band extends through between the supports 2 and 2′ and is thus guided in particular sideways in order to avoid the saw band tipping up.

The band guiding unit 1 includes, over and above this, a mounting block 4 for mounting onto the saw upper part (not shown) of a band saw, a band guiding block 5 which in particular includes the two band guiding device 2, 3 which are developed according to the invention as well as a coolant supplying means 6 by means of which coolant can be supplied up to a coolant outlet 7. Liquid coolant finally passes via the coolant outlet 7 to the saw band which is guided through between the two supports 2, 2′ as well as finally between the saw band and the sliding blocks 3, which brings about a lubricating as well as a cooling effect.

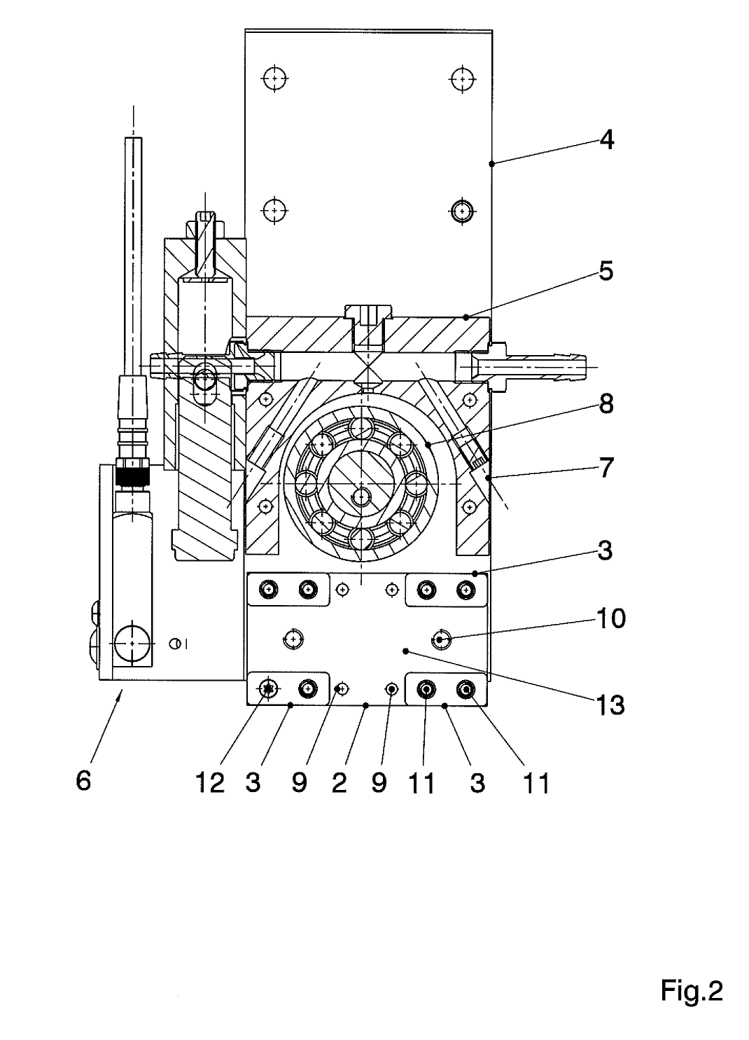

FIG. 2 shows a schematic sectional representation where the cut extends in the plane of the saw band (not shown) between the two supports 2, 2′ according to FIG. 1, the interior of the band guiding block 5 which forms the band guiding unit 1 together with the mounting block 4 and the coolant supplying means 6. A band back guiding means 8, which is realized as a mounted roller in order to be able to roll along the back of the band in as friction-free a manner as possible, is arranged above the band guiding device which is developed according to the invention with the support 2 and the sliding blocks 3. The cutting force necessary for machining the material to be sawn is applied onto the saw band by means of said band back guiding means 8.

The exemplary embodiment shown in FIG. 2 for the band guiding device which are developed according to the invention for the sideways guiding of the saw band consists of the support 2 and four sliding blocks 3 which, in each case, are fastened by means of screw connections in a releasable manner on the support 2 or on its flatly formed mounting surface 13. For this purpose, the sliding blocks 3 have in each case two countersunk bores 11 for receiving screws 12, in the present case only one screw 12 being indicated in the sliding block 3 which is arranged on the bottom left.

The mounting surface 13 of the support 2, along with the fastening points on which the sliding blocks 3 are fastened, comprises further fastening points in order to be able to move the sliding blocks 3 when required. For example, depending on the saw band used, it can be advantageous to move the sliding block 3 shown on the bottom left by one fastening point 9 to the right and so on. The fastening points 9 are developed as threaded bores in this exemplary embodiment.

The support 2 is also fastened in a releasable manner by means of fixing screws 10 on the band guiding block 5 of the band guiding unit 1 and consequently finally on the machine saw. For reasons of stability and anti-rotation protection, two fixing screws 10 are provided, and all the sliding blocks 4 are provided with, in each case, two countersunk bores 11 in order to be able to fasten them with, in each case, two screws on the mounting surface 13 of the support 2.

A perspective representation and a side sectional representation of a sliding block 3 from FIG. 2 are shown in detail in FIGS. 3 and 4. This sliding block 3 has been pressed from metal powder and hardened as a result of sintering. It has two countersunk bores 11 which make it possible to sink the screws 12 so deeply into the sliding block 3 that the heads thereof come to lie a few millimeters below the surface of the sliding block 3. The sliding block 3 is consequently able to wear by a few millimeters as a result of frictional contact with the saw band without the resultant removal of material resulting in the risk of the screws 12 coming onto contact with the saw band.

The edges of the sliding block 3, which delimit the surface thereof which is provided for sliding contact with the saw band, are, as FIG. 4 makes clear, rounded for protecting the saw band. The height of the sliding contact 3, which is placed flatly onto the mounting surface 13 of the holder 2 and is then screw-connected to said mounting surface, ensures that the saw band is at a particularly large spacing from the mounting surface 13 of the support 2. The resultant particularly large clearance occurring between the mounting surface 13, the sliding block 3 and the saw band prevents in a reliable manner any chips from being able to settle and collect on the band guiding device.

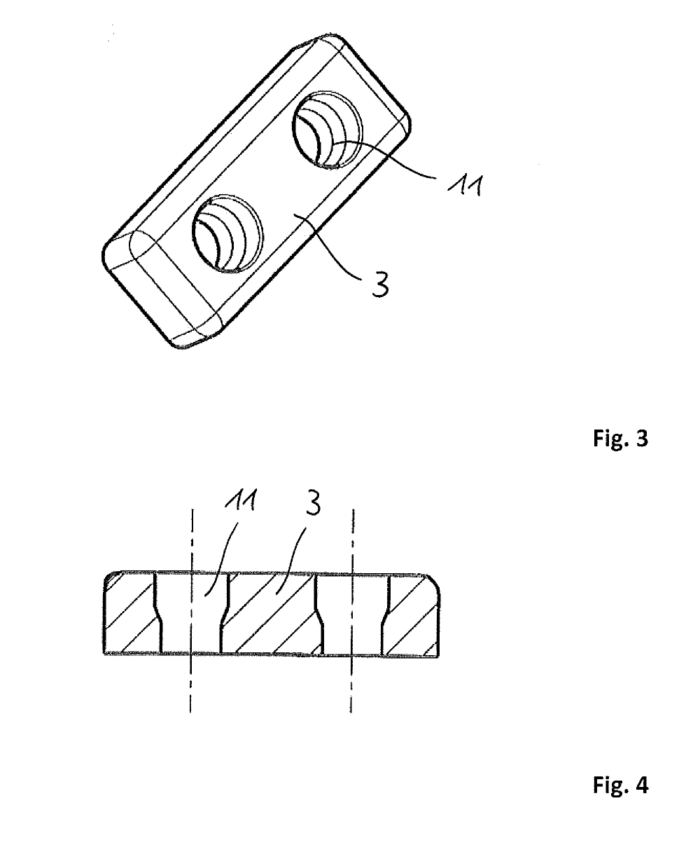

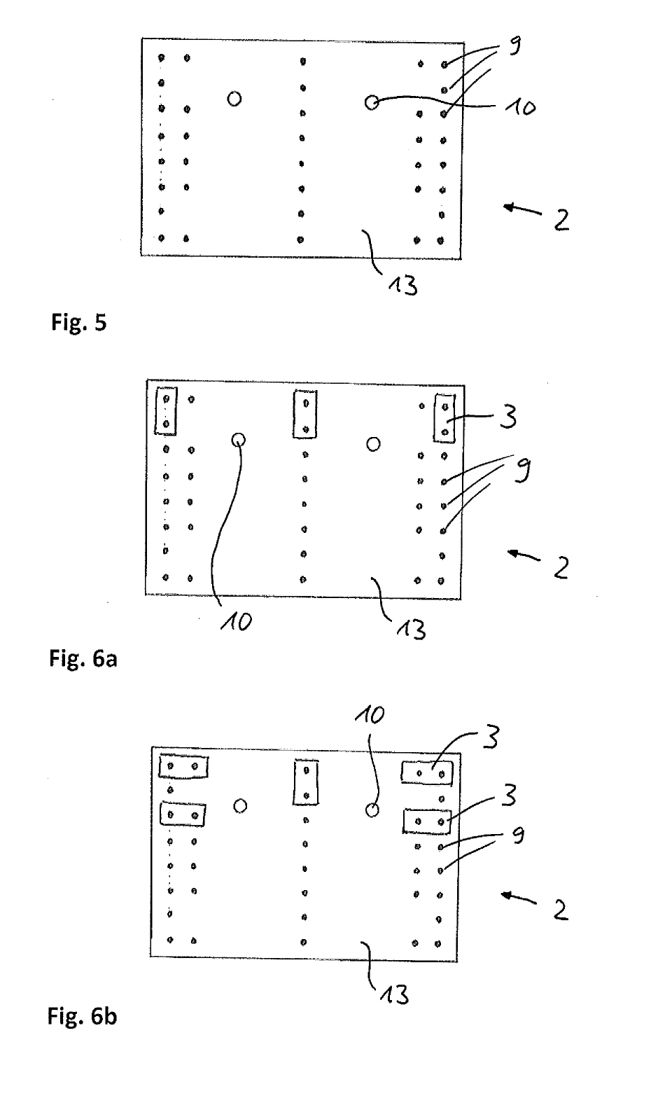

FIG. 5 shows a top view of the mounting surface 13 of a support 2 of a further exemplary embodiment of a band guiding device according to the invention. This support 2 is provided with a plurality of fastening points 9 which are arranged in an irregular grid and enable the most varied arrangements of sliding blocks 3.

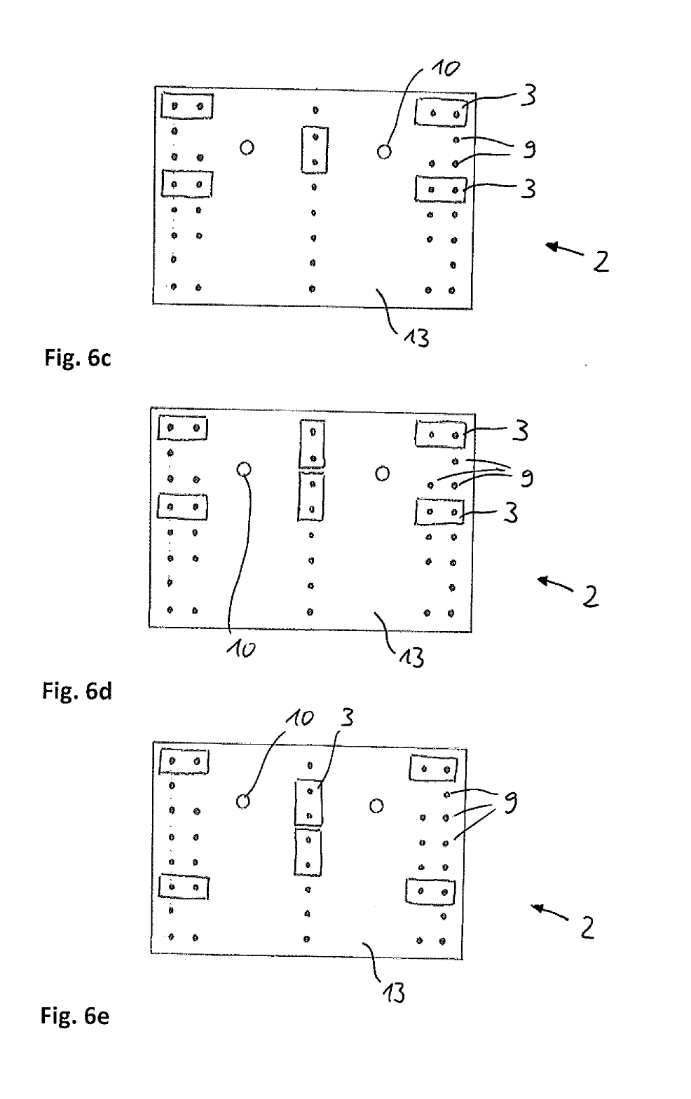

Some examples of different arrangements of sliding blocks 3 on the mounting surface 13 of the support 2 represented in FIG. 5 are shown in FIGS. 6a to 6e. The arrangement of the sliding blocks 3 in FIG. 6a serves for guiding a saw band with a small saw band width, whereas the arrangements in FIGS. 6b, 6c, 6d and 6e are provided for saw bands the width of which increases in each case by one stage. All the arrangements of sliding blocks 3 shown in FIG. 6 can be realized on one and the same support 2, which is shown in FIG. 5. Using this modular system, savings can be obtained for the production and storage of spare parts both on the part of the manufacturer and on the part of the user.

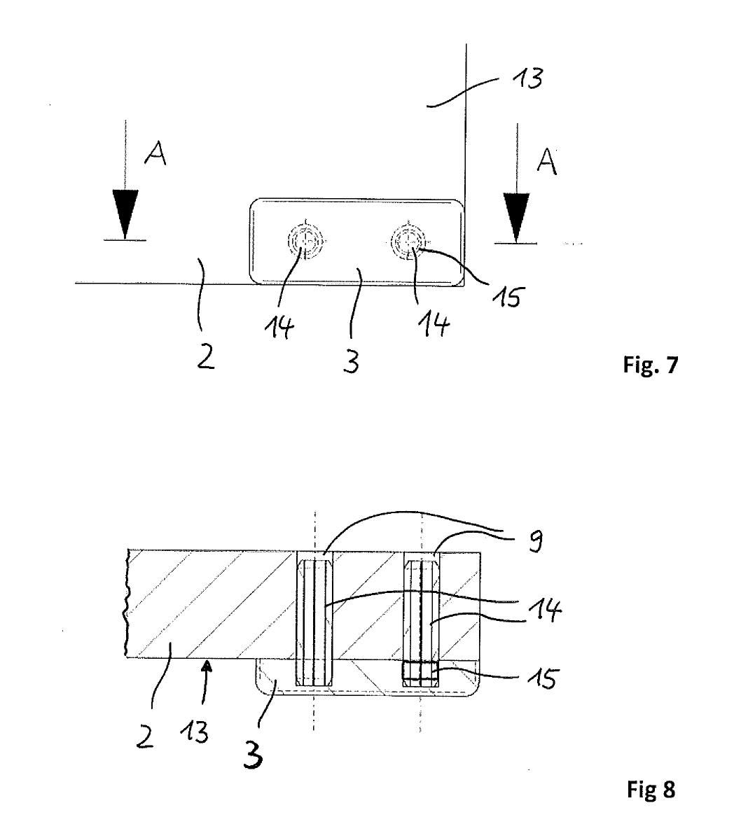

FIGS. 7 and 8 show part of another exemplary embodiment of a band guiding device which is developed according to the invention with support 2 and sliding block 3, FIG. 7 in a top view onto the mounting surface 13 of the support 2 and the surface of the sliding block 3 and FIG. 8 in section along the line A-A according to FIG. 7.

In this case the sliding block 3 once again is formed of a pressed metal powder which has been hardened as a result of sintering and is once again fastened at two fastening points 9 on the support 2. However, in this exemplary embodiment, said fastening points 9 are not developed as threaded bores but as cylindrical bores into which cylindrical pins 14 are inserted. These cylindrical pins 14 are inserted into cylindrical openings on the back of the sliding block 3, a clamping sleeve 15 which sits on the pin 14 ensuring that the pin 14 is secured in the sliding block 3, as indicated in FIG. 8, such that the sliding block 3 is not able to fall off the support 2. The forces which are exerted by the saw band (not shown) onto the sliding block 3 act in the direction of the mounting surface 13 of the support 2 and/or parallel to said mounting surface 13, but never directed away from the mounting surface 13. Consequently, it is sufficient for the clamping sleeve 15 to secure the sliding block 3 again falling out; the prevailing forces are taken up, apart from this, by the pins 14 which in this respect sit in a positive locking manner in the support 2 and in the sliding block 3.

As FIG. 8 finally also illustrates, in this exemplary embodiment the surface of the sliding blocks 3, which come into contact with the saw band, is closed; there are no countersunk bores in said surface, which, depending on the area of application, can be advantageous.

1. A band guiding device for a saw band of a machine saw, comprising sliding blocks (3) for sliding contact with the saw band and a support (2) that is mountable on the machine saw and on which the sliding blocks (3) are held by releasable fastening elements (9, 12), the support (2) comprises a substantially flat mounting surface (13) for mounting the sliding blocks (3), and the mounting surface (13) includes a plurality of fastening points (9) for the sliding blocks (3), and a number of the fastening points (9) is greater than a number of sliding blocks (3).

2. The band guiding device according to claim 1, wherein the fastening points (9) are arranged on the support (2) in such a manner that the sliding blocks (3) are movable on the support (2) to adapt the band guide to different saw bands.

3. The band guiding device according to claim 1, wherein the fastening points (9) are arranged on the support (2) in a grid.

4. The band guiding device according to claim 1, wherein the fastening elements include screws (12) or threaded pins and threaded bores, and the fastening points (9) in the mounting surface (13) are each formed as at least one threaded bore.

5. The band guiding device according to claim 4, wherein the sliding blocks (3) are provided with at least two countersunk bores (11) for inserting screws (12) in a countersunk manner, and the fastening points (9) in the mounting surface (13) are formed in each case of at least two threaded bores.

6. The band guiding device according to claim 1, wherein the fastening elements are provided for producing positive locking push-in connections between the sliding blocks (3) and the support (2).

7. The band guiding device according to claim 6, wherein the fastening elements comprise self-locking pins (14) with clamping sleeves (15).

8. The band guiding device according to claim 6, wherein the fastening elements include a groove introduced into the mounting surface (13) for receiving a sliding block (3), and the groove comprises a stop face in the direction of movement of the saw band for locating the sliding block (3).

9. The band guiding device according to claim 8, wherein a stop face is provided with an undercut, and the sliding block (3) comprises a molded part for inserting into the undercut of the stop face.

10. The band guiding device according to claim 1, wherein the sliding blocks (3) are produced from at least one of a metal powder or ceramic material which is pressed in a mold and hardened by sintering.
